(19) United States
(12) Patent Application Publication
(10) Pub. No.: US 2005/0270993 A1
(43) Pub. Date: Dec. 8, 2005

(54) Efficient partitioning of MAC (media access control) functions

(76) Inventors: Krishnan Rajamani, San Diego, CA (US); Jaya Jeyaseelan, San Diego, CA (US); Tejaswini, San Diego, CA (US)

Correspondence Address: INTEL CORPORATION, P.O. BOX 5326, SANTA CLARA, CA, 95056-5326, US

(21) Appl. No.: 10/863,307

(22) Filed: Jun. 7, 2004

(51) Int. Cl. G08C 17/00

(52) U.S. Cl. 370/311; 370/468

(57) ABSTRACT

In one embodiment, a method is provided. The method of this embodiment provides Therefore, in one embodiment, a method may include performing real-time MAC (media access control) functions, and at least one non real-time MAC function of a plurality of non real-time MAC functions on a network device of a system on a network; and performing others of the plurality of non real-time MAC functions on a host processor of the system on the network.

### FIELD

Embodiments of this invention relate to efficient partitioning of MAC (media access control) functions.

### BACKGROUND

The MAC is a protocol that controls how a computer on a network gains access to the data and permission to transmit it. In one embodiment, the MAC may be a sublayer of the Data Link layer of the Open System Interconnection (OSI) model for networking protocols. The OSI model defines a networking framework for implementing protocols in seven layers, where each layer may provide one or more programs to support a type of process or processes. The OSI model is defined by the International Organization for Standardization (ISO) located at 1 rue de Varembé, Case postale 56 CH-1211 Geneva 20, Switzerland. Different networking protocols may be based on the OSI model, but may not necessarily adopt each of the layers defined by the OSI model.

In early generation MAC implementations, MAC functions were performed on a network device, such as a NIC (network interface card). To improve system cost and performance, current solutions may partition MAC functions between the network device and a host processor (hereinafter “host”). For example, in one prior art example, real-time functions may remain on the device, and non real-time functions may be moved to the host. Real-time functions refer to functions that may be time-sensitive, such as rate selection, and non real-time functions refer to functions that may not be time-sensitive, such as the generation of acknowledgements.

As power consumption and network synchronization become increasingly important, such as in wireless systems, different partitioning of MAC functions may be made to take advantage of the processing power and memory of the host and device to further improve, for example, system cost and performance.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a network according to one embodiment.

FIG. 2 illustrates system according to one embodiment.

FIG. 3 illustrates a method according to one embodiment.

FIG. 4 illustrates another method according to one embodiment.

FIG. 5 illustrates a method according to another embodiment.

### DETAILED DESCRIPTION

Examples described below are for illustrative purposes only, and are in no way intended to limit embodiments of the invention. Thus, where examples may be described in detail, or where a list of examples may be provided, it should be understood that the examples are not to be construed as exhaustive, and do not limit embodiments of the invention to the examples described and/or illustrated.

Embodiments of the present invention may be provided, for example, as a computer program product which may include one or more machine-accessible media having machine-executable instructions that, when executed by one or more machines such as a computer, network of computers, or other electronic devices, may result in the one or more machines carrying out operations in accordance with embodiments of the present invention. A machine-accessible medium may include, but is not limited to, floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable media suitable for storing machine-executable instructions.

Moreover, embodiments of the present invention may also be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

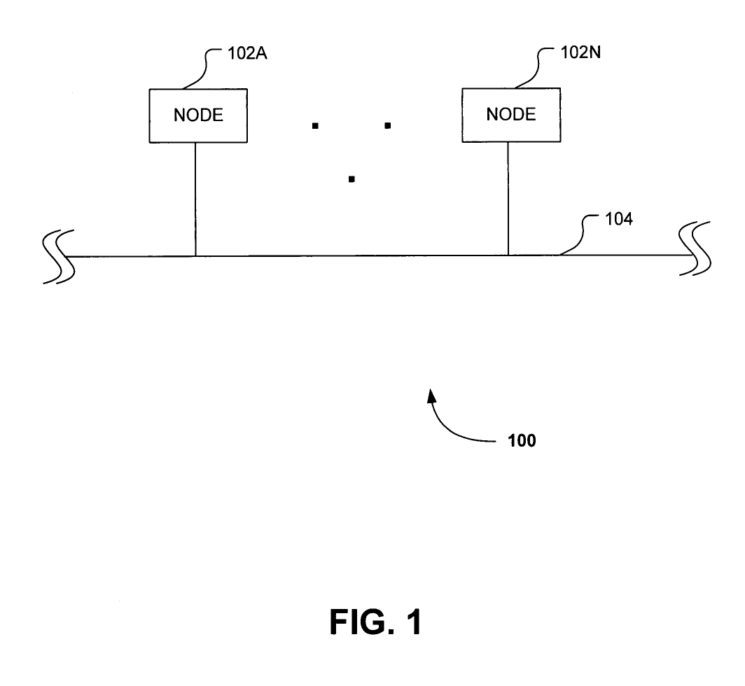

FIG. 1 illustrates a network 100 in which embodiments of the invention may operate. Network 100 may comprise a plurality of nodes 102A, . . . 102N, where each of nodes 102A, . . . 102N may be communicatively coupled together via a communication medium 104. As used herein, components that are “communicatively coupled” means that the components may be capable of communicating with each other via wirelined (e.g., copper wires), or wireless (e.g., radio frequency) means.

As used herein, a “communication medium” means a physical entity through which electromagnetic radiation may be transmitted and/or received. Communication medium 104 may comprise, for example, one or more optical and/or electrical cables, although many alternatives are possible. For example, communication medium 104 may comprise, for example, air and/or vacuum, through which nodes 102A . . . 102N may wirelessly transmit and/or receive sets of one or more signals. Furthermore, nodes 102A . . . 102N may transmit and receive sets of one or more signals via medium 104 that may encode one or more packets. As used herein, a “packet” means a sequence of one or more symbols and/or values that may be encoded by one or more signals transmitted from at least one sender to at least one receiver. In network 100, one or more of the nodes 102A . . . 102N may comprise one or more intermediate stations (not shown), such as, for example, one or more hubs, switches, and/or routers; additionally or alternatively, one or more of the nodes 102A . . . 102N may comprise one or more end stations. Communication medium 104 may communicatively couple together at least some of the nodes 102A . . . 102N and one or more of these intermediate stations. Of course, many alternatives are possible.

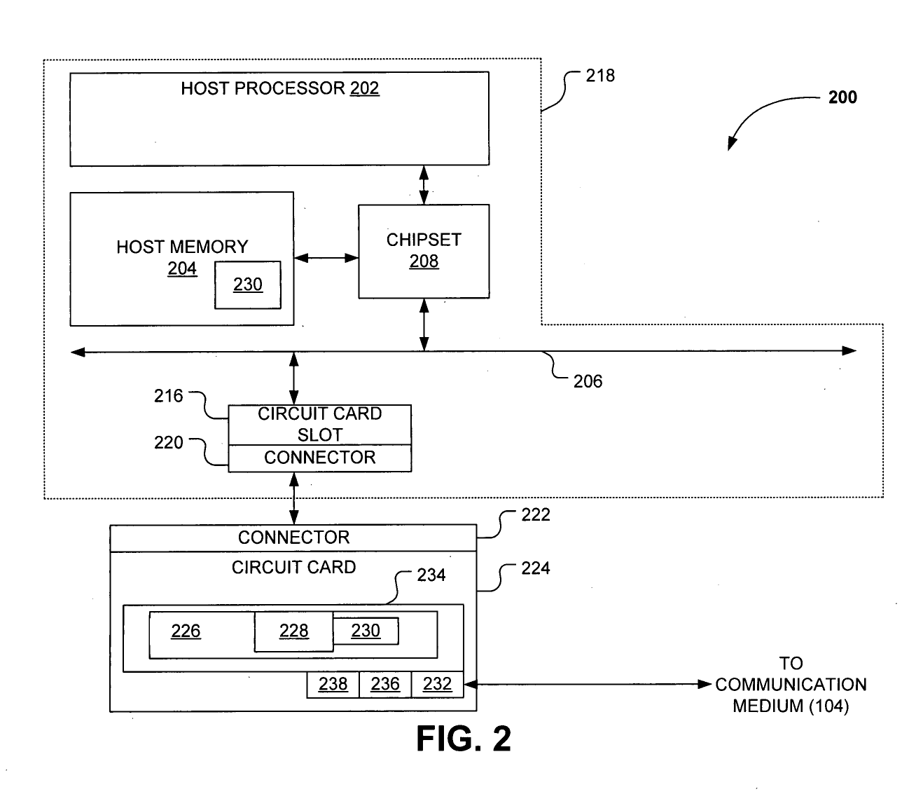

At least one of nodes 102A, . . . , 102N may comprise system 200, as illustrated in FIG. 2. System 200 may comprise host processor 202, bus 206, chipset 208, circuit card slot 216, and connector 220. System 200 may comprise more than one, and other types of processors, buses, chipsets, circuit card slots, and connectors; however, those illustrated are described for simplicity of discussion. Host processor 202, bus 206, chipset 208, circuit card slot 216, and connector 220 may be comprised in a single circuit board, such as, for example, a system motherboard 218.

Host processor 202 may comprise, for example, an Intel® Pentium® microprocessor that is commercially available from the Assignee of the subject application. Of course, alternatively, host processor 202 may comprise another type of microprocessor, such as, for example, a microprocessor that is manufactured and/or commercially available from a source other than the Assignee of the subject application, without departing from this embodiment.

Chipset 208 may comprise a host bridge/hub system that may couple host processor 202, and host memory 204 to each other and to bus 206. Chipset 208 may include an I/O bridge/hub system (not shown) that may couple a host bridge/bus system of chipset 208 to bus 206. Alternatively, host processor 202, and/or host memory 204 may be coupled directly to bus 206, rather than via chipset 208. Chipset 208 may comprise one or more integrated circuit chips, such as those selected from integrated circuit chipsets commercially available from the Assignee of the subject application (e.g., graphics memory and I/O controller hub chipsets), although other one or more integrated circuit chips may also, or alternatively, be used.

Bus 206 may comprise a bus that complies with the Peripheral Component Interconnect (PCI) Local Bus Specification, Revision 2.2, Dec. 18, 1998 available from the PCI Special Interest Group, Portland, Oreg., U.S.A. (hereinafter referred to as a “PCI bus”). Bus 206 may comprise other types and configurations of bus systems. For example, bus 206 may comprise a bus that complies with the Mini PCI Specification Rev. 1.0, also available from the PCI Special Interest Group, Portland, Oreg., U.S.A.

System 200 may comprise one or more memories to store machine-executable instructions 230 capable of being executed, and/or data capable of being accessed, operated upon, and/or manipulated by circuitry, such as circuitry 226. For example, these one or more memories may include host memory 204, and/or memory 228. One or more memories 204 and/or 228 may, for example, comprise read only, mass storage, random access computer-accessible memory, and/or one or more other types of machine-accessible memories. The execution of program instructions 230 and/or the accessing, operation upon, and/or manipulation of this data by circuitry 226 may result in, for example, system 200 and/or circuitry 226 carrying out some or all of the operations described herein.

System 200 may comprise circuit card slot 216 and circuit card 224. Circuit card slot 216 may comprise a PCI expansion slot that comprises a PCI bus connector 220. PCI bus connector 220 may be electrically and mechanically mated with a PCI bus connector 222 that is comprised in circuit card 224. Circuit card slot 216 and circuit card 224 may be constructed to permit circuit card 224 to be inserted into circuit card slot 216. When circuit card 224 is inserted into circuit card slot 216, PCI bus connectors 220, 222 may become electrically and mechanically coupled to each other. When PCI bus connectors 220, 222 are so coupled to each other, circuitry 226 in circuit card 224 may become electrically coupled to bus 206. When circuitry 226 is electrically coupled to bus 206, host processor 202 may exchange data and/or commands with circuitry 226, via bus 206 that may permit host processor 202 to control and/or monitor the operation of circuitry 226.

Circuit card 224 may comprise transceiver circuitry 232. As used herein, “transceiver circuitry” refers to a receiver to receive packets and a transmitter to transmit packets. It will be appreciated, of course, that a receiver and a transmitter may each be embodied in its own circuitry, instead of transceiver circuitry 232, without departing from embodiments of the invention. Transceiver circuitry 232 may be communicatively coupled to medium 104.

Circuitry 226 may comprise computer-readable memory 228. Memory 228 may comprise read only and/or random access memory that may store program instructions 230. These program instructions 230, when executed, for example, by circuitry 226 may result in, among other things, circuitry 226 executing operations that may result in system 200 carrying out the operations described herein as being carried out by system 200, and/or circuitry 226.

Circuitry 226 may comprise one or more circuits to perform one or more operations described herein as being performed by circuitry 226, network device 234, or host processor 202. These operations may be embodied in programs that may perform functions described below by utilizing components of system 200 described above. Circuitry 226 may be hardwired to perform the one or more operations. For example, circuitry 226 may comprise one or more digital circuits, one or more analog circuits, one or more state machines, programmable circuitry, and/or one or more ASIC's (Application-Specific Integrated Circuits). Alternatively, and/or additionally, circuitry 226 may execute machine-executable instructions 230 to perform these operations.

Instead of being comprised in circuit card 224, some or all of circuitry 226 may instead be comprised in host processor 202, or chipset 208, and/or other structures, systems, and/or devices that may be, for example, comprised in motherboard 218, and/or communicatively coupled to bus 206, and may exchange data and/or commands with one or more other components in system 200.

In one embodiment, circuitry 226 may be comprised in a network device 234. Network device 234 may comprise, for example, a wireless NIC. Rather than being comprised in a circuit card 224 as illustrated in FIG. 2, network device 234 may alternatively be built-in, such as being comprised on motherboard 218 without departing from embodiments of the invention.

In one embodiment, system 200 may comprise a station that complies with the IEEE (Institute for Electrical and Electronics Engineers) 802.11 standard. The IEEE 802.11 standard is a standard that defines a protocol for wireless communication between stations. The standard is defined in the Institute for Electrical and Electronics Engineers standard 802.11, 1997 edition, available from IEEE Standards, 445 Hoes Lane, P.O. Box 1331, Piscataway, N.J. 08855-1331.

A “station” as used herein refers to a node in a network. In one embodiment, stations may communicate with each other using a protocol such as IEEE 802.11. Stations may operate in a BSS (Basic Service Set) network, or in an IBSS (Independent Basic Service Set) network. A BSS network may comprise a set of IEEE 802.11-compliant stations that operate as a fully connected wireless network. In a BSS network, stations may comprise clients and AP's. An “AP” is a station that may act as an interface between a wireless network, such as a BSS network, and a wired network, and a “client” is a station that may receive services of a network, such as a BSS network. An AP may facilitate communication on the BSS network by sending out beacons to clients. A “beacon” is a type of frame that may be transmitted periodically to allow clients in a network to locate and identify the network. An IBSS network is a type of BSS network that may operate without an AP. In an IBSS network, stations may comprise clients. In an IBSS network, each client may function as an AP does in a BSS.

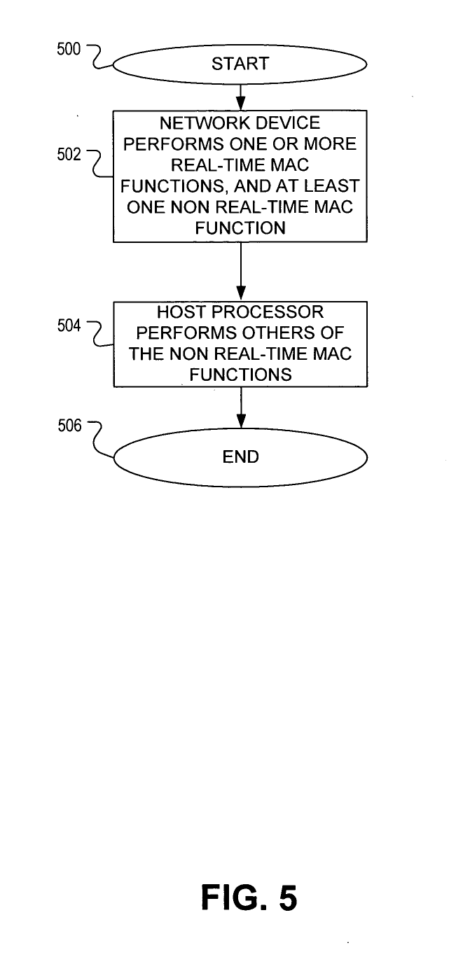

FIG. 5 illustrates a method in accordance with one embodiment. The method begins at block 500 and continues to block 502 where network device 234 may perform one or more real-time MAC functions, and at least one non real-time MAC function. Real-time functions refer to functions that may be time-sensitive. In one embodiment, real-time functions may include, for example:

Channel access, as described in the IEEE 802.11 specification.

MAC frame check sequence verification, as described in the IEEE 802.11 specification.

Acknowledgement protocol, such as sending and receiving ACK frames, as described in the IEEE 802.11 specification.

Network allocation vector (NAV), as defined in the IEEE 802.11 specification.

Scan implementation, such as parking the PHY on the request channel, generating probe requests on the channel, and keeping the Receiver on to receive probe responses and/or beacons which are forwarded to the host.

Transmit scheduling from system memory queues, such as selecting the appropriate queue from which to send the next packet, per IEEE 802.11e specification.

CF (contention Free) Awareness, such as honoring contention free periods requested by the AP.

RTS (Request to Send)/CTS (Clear to Send) protocol, such as the generation and timing of the optional RTS/CTS packets.

Backoff selection, such as computation of the number of slots to wait before attempting transmission per IEEE 802.11 specifications.

Determining the precise timing of inter-frame-space durations, as described in the IEEE 802.11.

MAC frame header, such as generation of a subset of the fields of the MAC header for outgoing packets, and processing a subset of the fields of the MAC header in incoming packets.

TSF (Timing Synchronization Function) maintenance, such as updating the local TSF timer based on beacons received from the network.

Address filtering, such as parsing of the address fields in the MAC header in packets received from the network and selecting which frames to forward to the host.

Encryption/decryption, such as the encoding and decoding of the MAC payload with the appropriate keys, as described in the IEEE 802.11 specification.

Movement of data between local FIFOs (first-in-first-out), the network device (i.e., NIC), and system memory queues on the host by the NIC, without requiring the host processor to execute instructions to move the data.

Processing the related bus power management transactions initiated by the host processor.

At least one of the non real-time functions that network device 234 may perform include:

Transmit retries: if an acknowledgement for a packet transmitted earlier is not received from the network as described in the IEEE 802.11 specification, network device 234 may subsequent attempt to re-send the same packet, as described in the IEEE 802.11 specification.

Rate decisions for retries, such as setting the transmission speed on subsequent attempts to re-send the same packet.

Beacon frame filtering in power save state in BSS mode, such as processing the appropriate fields in beacons received from the network to decide whether the host processor needs to be awakened to process the beacon.

Listen interval enforcement, receiver wakeup logic, such as timer logic for waking up periodically to enable the transceiver 232 to receive a beacon, as proscribed by the host selection of the periodicity.

Multicast filtering, such as processing of the multicast address in multicast frames received from the network, comparing them against a set of addresses specified the host, and forwarding the packet to the host only if there is a match.

Beacon transmission with host-specified content, such as maintaining timer logic for when to generate a beacon (with a host-proscribed periodicity), and using the content specified by the host to construct the beacon packet.

Probe response transmission with host-specified content, such as responding to a probe request received from the network with a probe response constructed using host-specified content.

At block 504, host processor 202 may perform others of the non real-time MAC functions. Non real-time functions refer to functions that may not be time-sensitive. Others of non real-time functions that host processor 202 may perform may include, for example:

Beacon content generation.

Probe response content generation.

Roaming, including policy and mechanisms to associate with a different AP.

Null data generation for power save state change, including queuing of a null frame for transmission by the NIC.

Scan initiation, including decisions to scan one or more channels for the presence of an AP, and sending a command to the NIC to perform the scan.

Transmit queues based on priorities and/or destination, such as placing data sent by upper layers of the stack into the appropriate queues which may be accessed by the NIC.

Transmit fragmentation and receive reassembly.

Initial transmit rate decisions, long term rate scaling, including the selection of the transmission speed for the first attempt by the NIC to send a packet queued by the host, as well the policies for changing this value per packet.

IEEE 802.11(d)-related processing, including processing all the fields in the beacons and probe responses received from the network, as described in the IEEE 802.11 specification. The IEEE 802.11(d) standard is set forth in “IEEE standard for information technology—telecommunications and information exchange between systems—local and metropolitan area networks—specific requirement. Part 11: wireless LAN medium access control (MAC) and physical layer (PHY) specification. Amendment 3: specifications for operation in additional regulatory domains”, published 2001 by IEEE.

Transmit power selection per packet, including selecting the RF (radio frequency) power level to be used by the NIC to transmit the packet.

Software encryption/decryption for fragmented MSDU (MAC service data units), including the encoding and decoding of the MAC payload for fragment packets with the appropriate keys, as described in the IEEE 802.11 specification.

Capability management, including sending the appropriate information elements in an Association Request/Response, processing the corresponding fields in an Association Response/Request message, specifying these fields in the content of beacons and probe responses to be sent by the NIC, and processing the fields in beacons and probe responses received from the network.

IEEE 802.11(h), including sending the messages described in the IEEE 802.11h specification, and processing these messages received from the network. The IEEE 802.11( ) standard is set forth in “IEEE Std. 802.11h-2003 (Amendment to IEEE Std 802.11, 1999 Edn. (Reaff 2003))”, published 2003 by IEEE.

Long-term PHY calibration, including the periodic calibration of the Physical layer hardware due to slow environmental changes.

Beacon processing in non power save mode, including the processing of every beacon received from the network when the station is not in Power Save state.

Device configuration and management.

Connection establishment and tear-down, including the polices for selecting which network to join/leave, and generating the appropriate management packets to be sent by the NIC, and processing the response management packets from the network.

The method ends at block 506.

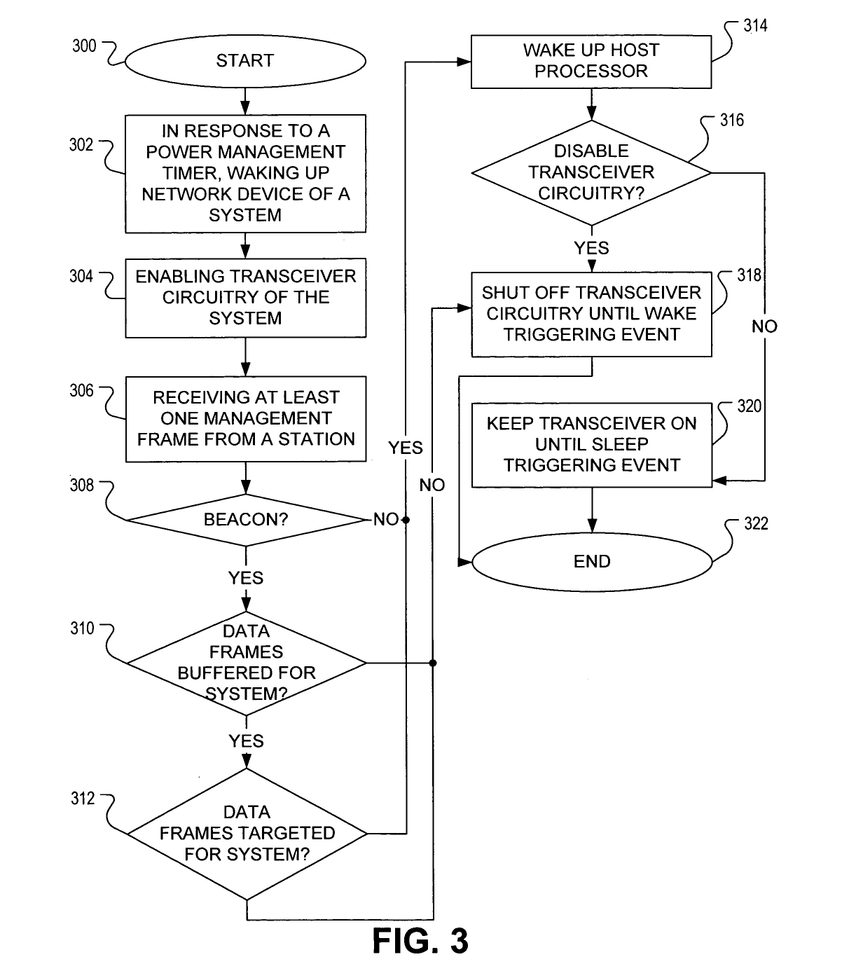

FIG. 3 illustrates a method in accordance with another embodiment of the invention. The method begins at block 300 and continues to block 302 where in response to a power management timer 236, network device 234 of system 200 may be awakened. Power management timer 236 may be programmed to wake up network device 234 at certain times. In one embodiment, the power management timer 236 may be set as a multiple of a beacon interval, and may be based, at least in part, on a user-specified power save state. For example, a user may specify a desire for lower system latency, but higher battery consumption in which case the system may wake up more often. Consequently, power management timer 236 may be programmed to wake up frequently in accordance with a given beacon interval.

At block 304, network device 234 may enable transceiver circuitry 232.

At block 306, network device 234 may receive a management frame from a station on network 100. A “frame” refers to a unit of transmitted information that may be encapsulated in one or more packets. A frame may include a management frame or a data frame. A data frame refers to a frame that encapsulates information that may come from higher layers, such as an application layer, and that may be consumable by a target device. Data frames may include, for example, data from web pages, or printer control data. In contrast, a management frame refers to a frame that encapsulates information to support data transfer.

In one embodiment, a management frame may comprise a beacon or a probe request. A beacon is a type of frame that may enable clients to locate and identify an IEEE 802.11 network. A beacon may include information such as a timestamp, beacon interval, and capability information. The timestamp is a value of a transmitting station's network synchronization timer 238 at the time that the beacon was transmitted. The beacon interval is the period between beacon transmissions. The capability information identifies the capabilities of the transmitting station. A beacon may also convey information to stations about data frames that may be buffered for the stations, such as during times of low power consumption. For example, the beacon may comprise a TIM (Traffic Indication Map), which may indicate whether the AP has buffered any frames for the station. A probe request is a type of frame that may be generated by a station to obtain information from another station. For example, a client in a BSS network may send a probe request to determine which access points are within range.

At block 308, network device 234 may determine if the management frame is a beacon. If the management frame is a beacon, then the method may continue to block 310. Otherwise, the management frame is a probe request, the method may continue to block 314.

At block 310, network device 234 may determine if the station has any data frames buffered for system 200. Network device 234 may determine this by, for example, parsing the TIM of the beacon. If at block 310, network device 234 determines that the station has one or more data frames buffered for system 200, the method may continue to block 312. Otherwise, if network device 234 determines that the AP does not have data frames buffered for system 200 at block 308, the method may continue to block 318.

At block 312, network device 234 may determine if the one or more data frames are targeted for system 200. A frame that is targeted for a system is a frame that is intended to be processed by the system. For example, a frame targeted for system 200 may comprise a multicast frame that passes the multicast filters of system 200. A multicast frame that passes the multicast filters of a system is a frame that is broadcast to a plurality of stations, and may be accepted by one or more of the stations as determined by their respective filters. For example, system's 200 multicast filter may include criteria for accepting frames from some AP's but not other AP's. In the case of multicast frames, network device 234 may receive the multicast frames, and examine the multicast address of the multicast frames against a list of multicast filters of system 200.

Other examples of frames targeted for system 200 may include unicast frames addressed to the system 200, and Wake frames addressed to the system 200. A unicast frame is a frame that is addressed to a single station. A Wake frame is also a frame that is addressed to a single station, but that may be designated for wake-on LAN (Local Area Network). Wake-on LAN systems may be capable of listening on the network for Wake frames using a network device 234, and of waking up the host processor 202 in response to the receipt of Wake-up frames.

If at block 312 frames are targeted for system 200, the method may continue to block 314. Otherwise the method may continue to block 318.

At block 314, network device 234 may wake up host processor 202. In one embodiment, management frame may comprise a beacon that indicates buffered data frames, and host processor 202 may receive the data frames, and perform other MAC functionality on the received data frames, such as reassembly of the data frames. In another embodiment, management frame may comprise a probe request, and host processor 202 may process the probe request by generating a probe response. The method may continue to block 316.

At block 316, network device 234 may determine if the transceiver circuitry 232 should be disabled. In one embodiment, network device 234 may disable transceiver circuitry 232 upon receipt of a probe request. In another embodiment, network device 234 may disable transceiver circuitry 232 if there are no pending unicast or multicast frames. If the received data frames are unicast frames, then the transceiver circuitry 232 may be disabled upon receipt of the unicast frames. On the other hand, if the frames are multicast frames, then the transceiver circuitry 232 may be left on until the multicast packets for the system have been received. If, at block 314, network device 234 disables transceiver circuitry 232, the method may continue to block 318. If, at block 316, network device 234 does not disable transceiver circuitry 232, the method may continue to block 320.

At block 318, network device 234 may disable transceiver circuitry 232 until a wake triggering event. A “wake triggering event” is an event that may wake up network device. A wake triggering event may include the next cycle of the power management timer, or when host processor 202 has management frames, such as beacons or probe responses, to transmit. The method may continue to block 322.

At block 320, network device 234 may keep transceiver 234 on until a sleep triggering event. A “sleep triggering event” is an event that may put network device to sleep. A sleep triggering event may include the receipt of unicast frames in accordance with the system's 200 receive policy for unicast frames. For example, system 200 may receive one or more packets of the unicast frames, and then shut off, or system 200 may receive all packets of the unicast frames, and then shut off. A sleep triggering event may also include the receipt of all multicast data, for example. Network device 234 may determine that all multicast data has been received by examining each packet that comes in, where each packet may have a flag that indicates whether there are more packets.

The method ends at block 322.

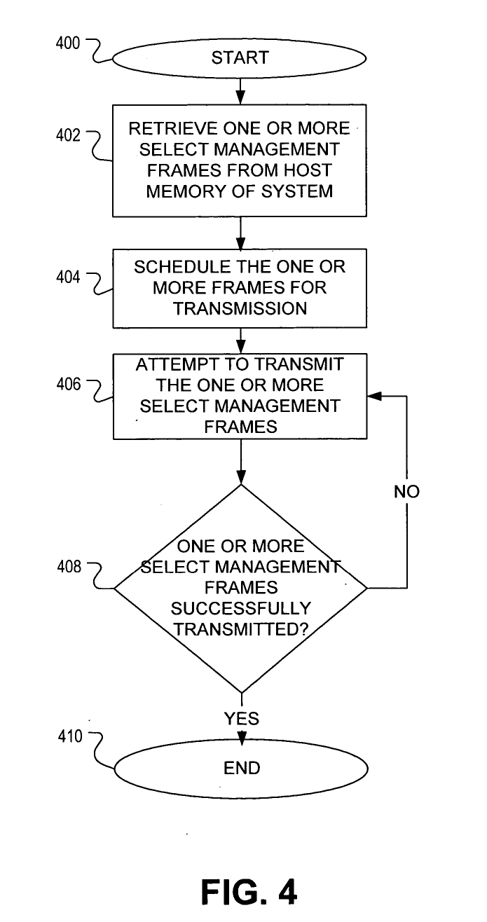

FIG. 4 is a flowchart that illustrates another method in accordance with one embodiment. The method begins at block 400, and continues to block 402 where network device 234 may retrieve one or more select management frames from host memory 204 of system 200. “Select management frames” refer to management frames that may be generated by host processor 202 and stored in host memory 204 for retrieval by network device 234. In one embodiment, select management frames may include beacons and probe responses. A probe response is similar to a beacon, except that it is only generated in response to a probe request.

In one embodiment, network device 234 may retrieve one or more select management frames based on a network synchronization timer 238. A network synchronization timer 238 may be maintained by a station to ensure that beacons are periodically transmitted. In another embodiment, network device 234 may retrieve one or more select management frames in response to receiving a probe request.

At block 404, network device 234 may schedule the one or more select management frames for transmission. Select management frames may be placed in transmit queues in network device 234, and may be scheduled according to an algorithm. For example, the algorithm may include a priority algorithm. Examples of priority algorithms include round robin; fairness, such as in accordance with IEEE 802.11(e) draft standard, as defined in the IEEE 802.11(e) standard, revision 8.0, available from IEEE; rotation order; and block mechanism. For example, in rotation order, a highest priority queue that was not selected on a previous cycle may be selected. As another example, in block mechanism, a transmit queue may be selected if it comprises a certain amount of data. Of course, other priority algorithms may be used.

At block 406, network device 234 may attempt to transmit the one or more select management frames.

At block 408, network device 234 may determine if the select management frames were successfully transmitted. In one embodiment, if network device 234 receives an acknowledgement from the receiving station, then the select management frames were successfully transmitted. If the select management frames were not successfully transmitted at block 408, then the method may revert to block 406 to perform one or more retries. The one or more retries may be attempted until the select management frames are successfully transmitted, and/or until network device 234 reaches a limit on the number of retries allowed, for example. Prior to or concurrently with any of the attempts to transmit the one or more select management frames, network device 234 may adjust the transmit rate based on a host-specified pattern. A host-specified pattern refers to a policy for retransmitting frames. For example, a host-specified pattern may indicate that there may be 5 retries, where the first 2 retries are sent at the highest transmission rate, and that each subsequent retry is sent at a transmission rate one notch lower. If the select management frames are successfully transmitted at block 408, then the method may continue to block 410.

The method ends at block 410.

### CONCLUSION

Therefore, in one embodiment, a method may comprise performing real-time MAC (media access control) functions, and at least one non real-time MAC function of a plurality of non real-time MAC functions on a network device of a system on a network; and performing others of the plurality of non real-time MAC functions on a host processor of the system on the network.

Embodiments of the invention may optimize the tradeoff between cost, network performance, and battery consumption. Wakeup logic, beacon frame filtering, multicast frame filtering, and frame retransmission on the device increase battery consumption by minimizing host processor intervention. Furthermore, determining transmission retries on the device, and using a host-specified pattern for retransmission results in better network performance since the decision to retry is almost instantaneous on the device, and the retry pattern may be dynamically adjusted. From a cost standpoint, device memory requirements may be kept to a minimum since not all MAC functionality is performed on the device.

In the foregoing specification, the invention has been described with reference to specific embodiments thereof. It will, however, be evident that various modifications and changes may be made to these embodiments without departing therefrom. The specification and drawings are, accordingly, to be regarded in an illustrative rather than a restrictive sense.

1. A method comprising:
performing real-time MAC (media access control) functions, and at least one non real-time MAC function of a plurality of non real-time MAC functions on a network device of a system on a network; and
performing others of the plurality of non real-time MAC functions on a host processor of the system on the network.

2. The method of claim 1, wherein the at least one non real-time MAC function comprises waking up the network device of the system in response to a power management timer of the network device.

3. The method of claim 2, wherein the at least one non real-time MAC function comprises multicast filtering.

4. The method of claim 1, wherein the at least one non real-time MAC function comprises transmitting select management frames from a memory of the system.

5. The method of claim 1, wherein the at least one non real-time MAC function comprises retrying the transmission one or more times.

6. The method of claim 5, additionally comprising adjusting the transmit rate prior to the one or more retries.

7. The method of claim 6, wherein the transmit rate is adjusted in accordance with a host-specified pattern.

8. A method on network device of a system on a network, comprising:
in response to a power management timer of the system, waking up the network device of the system;
enabling transceiver circuitry of the system;
receiving at least one management frame from a station on the network; and
if the at least one management frame is a beacon which indicates that there are one or more data frames buffered for the system, and if the one or more data frames are targeted for the system, then waking up a host processor of the system.

9. The method of claim 8, wherein data frames targeted for the system comprise one of the following:
multicast frames that pass the multicast filters of the system;
unicast frames addressed to the system; and
Wake frames.

10. The method of claim 9, additionally comprising shutting off the transceiver upon receipt of the data frames.

11. The method of claim 10, additionally comprising shutting off the transceiver circuitry until:
the next cycle of the power management timer where the host processor is not awakened; and
the host processor has data to send.

12. The method of claim 8, additionally comprising:
retrieving one or more select management frames for transmission from a memory of the system, the one or more select management frames being generated and stored in the memory by the host processor; and
scheduling the one or more select management frames for transmission.

13. The method of claim 12, additionally comprising if the one or more frames are not successfully transmitted from the memory, then retrying the transmission one or more times.

14. The method of claim 13, additionally comprising adjusting the transmit rate prior to the one or more retries.

15. The method of claim 14, wherein the transmit rate is adjusted in accordance with a host-specified pattern.

16. The method of claim 12, wherein the one or more select management frames comprise a beacon.

17. The method of claim 12, wherein the one or more select management frames comprise a probe response.

18. An apparatus comprising:
a network device capable of:
in response to a power management timer of the system, waking up the network device of the system;
enabling transceiver circuitry of the system;
receiving at least one management frame from a station on the network; and
if the at least one management frame is a beacon which indicates that there are one or more data frames buffered for the system, and if the one or more data frames are targeted for the system, then waking up a host processor of the system.

19. The apparatus of claim 18, wherein data frames targeted for the system comprise one of the following:
multicast frames that pass the multicast filters of the system;
unicast frames addressed to the system; and
Wake frames.

20. The apparatus of claim 18, additionally comprising:
retrieving one or more select management frames for transmission from a memory of the system, the one or more select management frames being generated and stored in the memory by the host processor; and
scheduling the one or more select management frames for transmission.

21. A system comprising:
a host processor;
a circuit board that includes a circuit card slot; and
a network device capable of being coupled to the circuit board via the circuit card slot, and having circuitry capable of:
in response to a power management timer of the system, waking up the network device;
enabling transceiver circuitry of the system;
receiving at least one management frame from a station on the network; and
if the at least one management frame is a beacon which indicates that there are one or more data frames buffered for the system, and if the one or more data frames are targeted for the system, then waking up the host processor.

22. The system of claim 21, the network device additionally capable of:
retrieving one or more select management frames for transmission from a memory of the system, the one or more select management frames being generated and stored in the memory by the host processor; and
scheduling the one or more select management frames for transmission.

23. The system of claim 22, the network device additionally capable of retrying the transmission one or more times if the one or more frames are not successfully transmitted from the memory.

24. The system of claim 23, the network device additionally capable of adjusting the transmit rate prior to the one or more retries.

25. The system of claim 21, wherein data frames targeted for the system comprise one of the following:
multicast frames that pass the multicast filters of the system;
unicast frames addressed to the system; and
Wake frames.

26. An article comprising a machine-readable medium having machine-accessible instructions, the instructions when executed by a machine, result in the following:
in response to a power management timer of the system, waking up a network device of the system;
enabling transceiver circuitry of the system;
receiving at least one management frame from a station on a network; and
if the at least one management frame is a beacon which indicates that there are one or more data frames buffered for the system, and if the one or more data frames are targeted for the system, then waking up a host processor of the system.

27. The article of claim 26, wherein the instructions additionally result in:
retrieving one or more select management frames for transmission from a memory of the system, the one or more select management frames being generated and stored in the memory by the host processor; and
scheduling the one or more select management frames for transmission.

28. The article of claim 27, wherein the instructions additionally result in retrying the transmission one or more times if the one or more frames are not successfully transmitted from the memory.

29. The article of claim 28, wherein the instructions additionally result in adjusting the transmit rate prior to the one or more retries.

30. The article of claim 26, wherein the data frames targeted for the system comprise one of the following:
multicast frames that pass the multicast filters of the system;
unicast frames addressed to the system; and
Wake frames.
